(19) United States
(12) Patent Application Publication
(10) Pub. No.: US 2013/0229033 A1
(43) Pub. Date: Sep. 5, 2013

(54) CAR SEAT

(71) Applicant: Peter John Sherwood Lee, Prattville, AL (US)

(72) Inventor: Peter John Sherwood Lee, Prattville, AL (US)

(21) Appl. No.: 13/768,803

(22) Filed: Feb. 15, 2013

(30) Foreign Application Priority Data
Feb. 16, 2012 (GB) 1202641.5

(51) Int. Cl. B60N 2/28

(52) U.S. Cl. CPC B60N 2/2848
USPC 297/130

(57) ABSTRACT

A car seat 10 comprises a seat 12, a first set of telescopic legs 22, a second set of legs 26 pivotally mounted to the seat 12, a first set of wheels 20 mounted to the first set of legs 22, and a second set of wheels 24 mounted to the second set of legs 26, each wheel 20,24 being moveable between a stowed position adjacent to the seat 12 and an operative position spaced from the seat 12, so that the seat 10 is able to transform between, for example, a pushchair and a car seat.

The present invention relates to a car seat and particularly but not exclusively to a car seat suitable for use both as a car seat and as a pushchair.

### BACKGROUND TO THE INVENTION

For a parent of a small child, there is a need to provide a seat to properly protect the child whilst travelling in a vehicle. There is also a need to provide easy means of transporting the child, who may not yet be able to walk long distances, whilst the parent is on foot.

Both child car seats and pushchairs are well known. These products respectively address the safety concerns which apply to the practice of transporting children in vehicles and provide the required means for a pedestrian parent to transport their child. However, a typical journey will call for both a car seat and a pushchair. Pushchairs can typically be folded, but nevertheless require significant storage space when not in use. It is therefore beneficial to provide a single apparatus which can provide the functions of both a car seat and a pushchair.

“Travel systems”, which comprise a pushchair frame and a car seat which can be fitted into the pushchair frame, are also available. These systems offer the advantage of allowing a sleeping child to be moved from the car to the pushchair with minimal disturbance, but still necessitate the separate transportation of the pushchair frame.

It is an object of this invention to provide a car seat which reduces or substantially obviates the above mentioned problems.

### STATEMENT OF INVENTION

According to the present invention there is provided a car seat for a child comprising a seat, the seat having a seat squab, a seat back, and first and second seat sides; first and second telescopic legs mounting respective first and second wheels, the first and second wheels being moveable between a stowed position adjacent to the first and second seat sides and an operative position spaced from the seat; first and second pivotally mounted legs mounting respective third and fourth wheels, the third and fourth wheels being moveable from a stowed position adjacent to the seat and an operative position spaced from the seat.

This arrangement allows the apparatus to be used both as a child car seat with the wheels in the stowed position, and as a pushchair with the wheels in the operative position.

The first and second pivotally mounted legs may be formed from two halves of the same member, so that angular motion of the legs is synchronised.

The pivotally mounted legs may pivot within a substantially horizontal mounting which is in turn mounted to the seat back.

A first locking mechanism may be disposed within the substantially horizontal mounting to prevent angular motion of the pivotally mounted legs other than when the device is in a transitional condition.

The first locking mechanism may be a toothed wheel and a pin. The advantage of this is that it allows the pivotally mounted legs to be locked in any one of a number of different positions, allowing the seat to be reclined (for example to accommodate a sleeping child) or held substantially upright. The first locking mechanism may alternatively consist of a sprung pin.

A second locking mechanism may be contained within the telescopic legs to prevent telescoping other than when the seat is in a transitional condition. The locking mechanism may consist of a sprung pin and an aperture to receive the pin on each of the telescopic legs.

Either or both of the locking mechanisms may be configured to automatically engage in either or both of the stowed and/or operative conditions. This provides the advantage of ensuring that the seat becomes safely locked without requiring user intervention.

A single handle may be mounted to the seat back to provide the means to disengage both the first and second locking mechanisms in order to move the wheels between the stowed positions and the operative positions. The handle may be connected to each of the locking mechanisms by means of Bowden cables. This provides the advantage of being able to disengage all the locking mechanisms in one operation.

In an alternative embodiment, separate handles may be mounted to the seat back to disengage the first and second locking mechanisms. The advantage of this is that the recline of the seat can be adjusted by altering the angular position of the rear wheel mountings, without unlocking the front wheel mountings. In this embodiment, the handle to disengage the second locking mechanism may be operatively connected with the handle to disengage the first locking mechanism such that the first locking mechanism is automatically disengaged when the second locking mechanism is disengaged. This retains the advantage of a single lever to operate both locking mechanisms and transform the chair, whilst still allowing the first locking mechanism to be operated independently to adjust the recline.

In a further alternative embodiment, one handle may be mounted to the seat back which when initially actuated disengages only the first locking mechanism and when further actuated disengages both locking mechanisms. This provides an alternative means of realising the above mentioned advantages of both a single lever and independent operation of the rear locking mechanism.

Biasing means may be applied to at least one of the moveable legs to retain the leg in either or both of the stowed and/or operative positions. The biasing means may be a spring. This provides the advantage of requiring positive force to transform the seat even in the event that one of the locking mechanisms becomes inadvertently disengaged.

Resistance means may apply controlled resistance to the movement of any of the moveable legs. This provides the advantage of a softer and more pleasing transition between conditions. The resistance means may be a pneumatic piston, spring or any spring-mass-damper arrangement.

A spar may be disposed between the telescopic legs, advantageously providing a foot rest which may be used by an occupant of the seat, and also providing a connection between the first and second telescopic legs so that the telescopic motion of one leg will be in synchrony with the telescopic motion of the other.

A cover may be disposed above the seat and attached to the telescopic legs in at least one attachment position. This provides protection from adverse weather for the seat and any occupant.

A restraint may comprise of first and second straps each anchored to the seat back at both ends, a third strap anchored at one end to the front of the seat squab, first and second moveable tongues attached to the first and second straps, and a buckle attached to the unanchored end of the third strap.

A handle may be disposed above the seat to facilitate handling and directing of the seat when being used as a pushchair. The handle may be mounted on telescopic members, which in turn may be pivotally mounted to the upper ends of the first and second telescopic legs. The advantage of, this arrangement is that the angular and linear position of the handle can be adjusted to suit operators of different physical builds.

A brake may be mounted on one or more of the wheels, providing the means to brake the seat on a non-level surface whilst configured as a pushchair.

The unattached edges of the seat squab, seat sides and seat back may include a rim.

Covers may extend from the rim substantially parallel to the first and second seat sides, defining spaces between the covers and seat sides for accommodating the wheels in the stowed condition.

The inside surfaces of the seat may be fully or partly covered with padding or cushioning, providing comfort for a child sat in the seat. The padding or cushioning may be a memory-foam material.

### DESCRIPTION OF THE DRAWINGS

For a better understanding of the present invention, and to show more clearly how it may be carried into effect, reference will now be made by way of example only to the accompanying drawings, in which:

FIG. 1 shows a perspective view of a car seat for a child configured for use as a pushchair;

FIG. 2 shows a perspective view of the car seat of FIG. 1 configured for use as a car seat;

FIG. 3 shows an alternative perspective view showing the rear of the car seat of FIG. 1 configured for use as a car seat;

FIG. 4 shows a perspective view of the car seat of FIG. 1 configured for use as a pushchair, and with a weatherproof cover fitted; and

FIG. 5 shows a side view of the car seat of FIG. 1 configured for use as a pushchair, and with a weatherproof cover fitted.

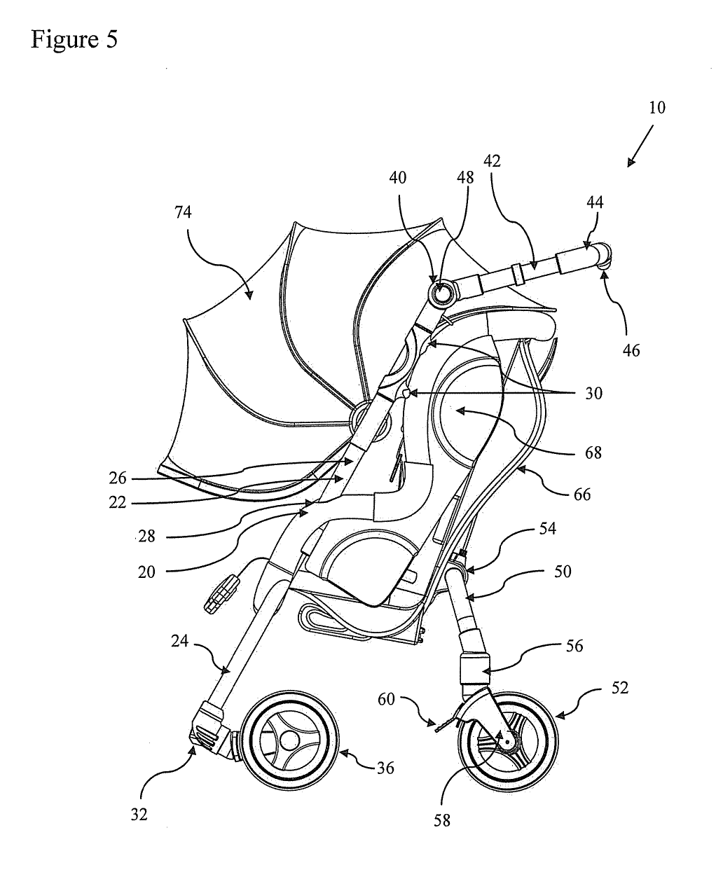

### DESCRIPTION OF PREFERRED EMBODIMENT

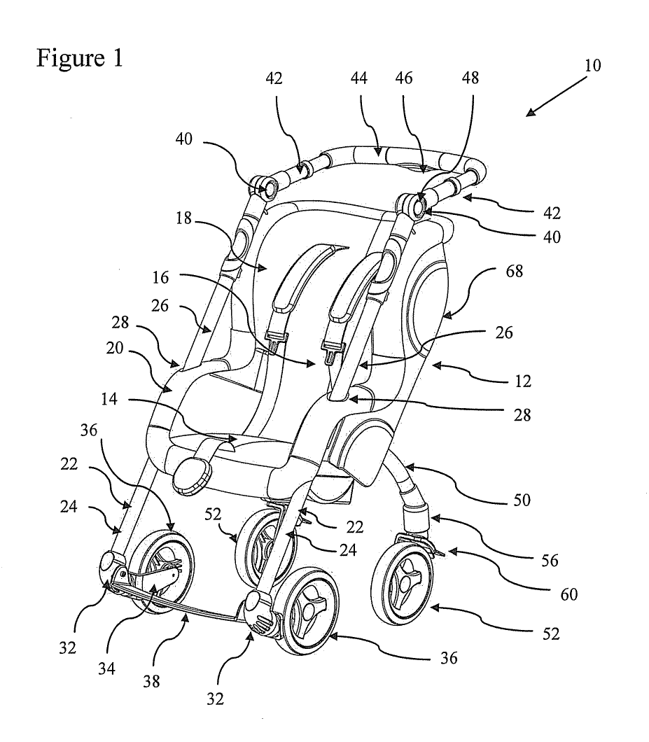

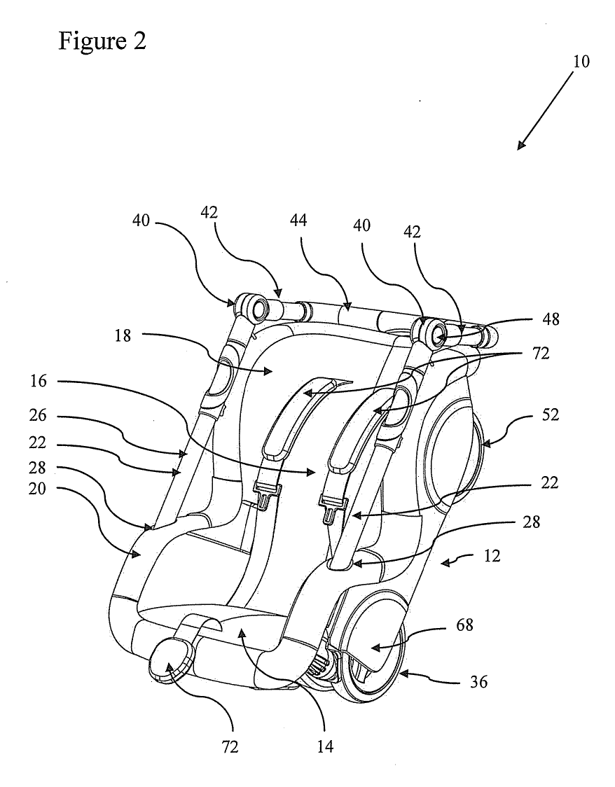

Referring firstly to FIGS. 1 and 2, a first embodiment of a car seat for a child is indicated generally at 10. The car seat 10 comprises a seat 12 including a seat squab 14, a seat back 16, and seat sides 18. The seat 12 is moulded from plastics and the inside surfaces of the seat are padded or cushioned to provide a comfortable seating arrangement for a child. A smoothly curved rim 20 of around 60 mm is provided around the unattached edges of seat 12, which provides a comfortable surface for a child to rest his or her hands on.

Two telescopic legs 22 are disposed at the front of the seat 10 substantially parallel to the seat back 16. The telescopic legs 22 each comprise an inner telescopic element 24 and an outer telescopic element 26, the elements 24, 26 being substantially tubular and being sized so that the inner element 24 can move longitudinally within the outer element 26. Lower regions of the outer telescopic elements 26 are mounted in and pass through apertures 28 provided through the seat rim 20. Additionally, upper regions of the outer telescopic elements 26 are anchored to the seat rim 20 at an upper mounting point 30.

Midway down the length of the outer telescopic elements 26, the seat sides 18 and rim 20 both curve in a U-shape towards the back of the seat 16. Hence the outer telescopic elements 26 are substantially exposed in front of the seat rim 20 and provide a portion of the telescopic elements which can conveniently be gripped for handling of the seat 10.

Front wheel mounts 32 are fitted to the lower distal ends of the inner telescopic elements 24. The wheel mounts 32 are formed as sockets into which the inner telescopic elements 24 are engaged. An L-shaped wheel support 34 includes a substantially planar portion which extends from each wheel mount 32 on the inner side of the seat and mounts an axle, about which each front wheel 36 rotates. Each wheel mount 32 is formed as an elbow of around 90 degrees, with the respective wheel support being positioned behind the lower end of the inner telescopic member 24 in the intended forward direction of travel, as viewed in FIG. 1. The angling of each elbow has the effect of placing each front wheel 36 adjacent to a seat side 18, when the respective inner telescopic element 24 is fully retracted.

A spar 38 extends between and connects the wheel mounts 32 together. The spar 38 is pivotally mounted to the wheel mounts 32, and has at least a substantially flat central region. This provides a foot rest for the occupant of the seat whilst it is in a condition suitable for use as a pushchair, to prevent the occupant's feet from dragging on the ground. The ability of rotation of the spar allows it to adopt a position which is comfortable for the child.

The outer telescopic elements 26 extend beyond the top of the seat back and attach at their upper ends to pivotal connectors 40. Telescopic handle mounts 42 are attached to the pivotal connectors 40 and extend generally towards the rear of, and above, the seat. A handle 44 is disposed between the telescopic handle mounts 42 to allow an operator to push and direct the seat when it is configured for use as a pushchair. The telescopic handle mounts 42 and pivotal connectors 40 provide the means to adjust the displacement and angular position of the handle 44 with respect to the seat 12 to suit operators of different physical builds.

A first locking mechanism prevents telescoping of the telescopic handle mounts 42 when they are not being adjusted. The first locking mechanism consists of sprung pins contained within the inner element of each telescopic handle mount 42 and a number of apertures in the outer element of each telescopic handle mount 42. Retracting the sprung pin disengages the first locking mechanism to allow telescoping of the telescopic handle mounts 42. A spring loaded push button 46 is mounted on the handle 44 and provides the means to disengage the first locking mechanism. The push button 46 is connected to the sprung pins by means of cables contained within the telescopic handle mounts 42.

A second locking mechanism is contained within the pivotal connectors 40 to prevent angular motion of the telescopic handle mounts 42 other than when adjustment is in progress. The second locking mechanism is disengaged when the operator inwardly presses a push button 48 disposed at the centre of the pivotal connectors 40. Alternatively, a ratchet may be provided within the pivotal connectors, which can be moved on application of a force greater than that typically applied to the handle 44 for usual manoeuvring of the pushchair.

Rear legs 50 for mounting rear wheels 52 are pivotally and horizontally mounted to the seat back 16 by a mounting 54. In this embodiment the rear legs 50 consist of a single curved member which is mounted at its centre. Rear wheel mountings 56 are mounted at the ends of the rear legs 50. The rear wheel mounts 56 are formed as sockets similar to front wheel mounts 32. An L-shaped wheel support 58 includes a substantially planar portion which extends from each wheel mount 56 on the inner side of the seat and mounts an axle, about which each rear wheel 52 rotates. A foot operated brake 60 is provided on each of the rear wheels 52. This allows the operator to prevent the seat from moving whilst it is on an incline and configured in a condition suitable for use as a pushchair. The front and/or rear wheels 36, 52 are able to rotate about a further axis, perpendicular to the axis of their axles, enabling the car seat 10 to be steered in pushchair mode. Most preferably the rear wheels 50 rotate, to enable the foot operated brake lever 60 to be rotated through 180 degrees for stowage.

The movement and locking of the front and rear wheel positions will now be described.

A third locking mechanism is provided to prevent telescoping of the telescopic legs 22 other than when the seat is in a transitional condition. In the preferred embodiment the third locking mechanism consists of a sprung pin on each of the telescopic legs 22. The sprung pin is contained within the inner telescopic element 24 and extends substantially across the diameter of the legs. The pin engages in an aperture in the outer telescopic element 26. This type of locking arrangement between telescopic tubes is well-known.

A fourth locking mechanism is provided to prevent rotation of the pivotally mounted legs 50 about the mounting 54. In the preferred embodiment the second locking mechanism consists of a toothed wheel and a pin which engages between teeth to prevent rotation. The advantage of this is that the pivotally mounted legs 50 can be locked in substantially any position, allowing the seat to be reclined to accommodate a sleeping child. The fourth locking mechanism is enclosed within the pivotal mounting 54. It will be appreciated that a pin and aperture locking arrangement could also be utilised, as desired.

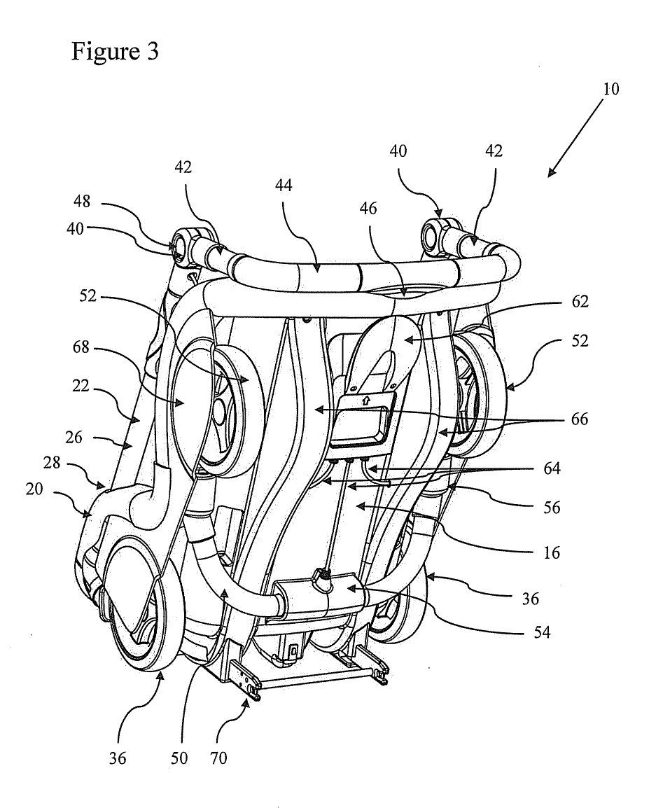

A lever 62, best seen in FIG. 3, provides the operator with the means to disengage the locking mechanisms on each of the legs 22,50 in order to transform the seat 10 from a car seat to a pushchair. Bowden cables 64 are provided to transmit a force from the lever 62 to each of the locking mechanisms. The advantage of this is that all the locking mechanisms can be operated easily with one motion. The lever 62 is attached to the upper seat back and connected to the third and fourth locking mechanisms by means of three Bowden cables 64. The Bowden cables 64 are routed through structural members 66 disposed on the back of the seat 16 from the lever 62 to the upper ends of the outer telescopic elements 26. The cables 64 then pass within the outer and inner telescopic elements 26, 24 to the third locking mechanism. In the case of the fourth locking mechanism, the Bowden cable 64 is routed directly from the lever 62 to the fourth locking mechanism in the pivotal mounting 54, disposed substantially parallel to the seat back 16.

Wheel guards 68 extend from the rim 20, substantially parallel to the seat sides 18. At least a portion of the wheels 36,52 in the stowed condition is disposed substantially between the seat sides 18 and the wheel guards 68. The advantage of this is that any dirt which may have built up on the wheels 36, 52 is covered and substantially prevented from being transferred to the upholstery of the car seat upon which the seat 10 is then placed. The child cannot generally touch the wheels when seated in the seat.

A fitting 70 is disposed at the bottom of the seat back at its rear to communicate with ISOFIX anchor points commonly fitted to vehicles. The advantage of this feature is that it allows easy but secure fitting to and release from a vehicle.

A harness 72 of a well-known design is provided to retain a child within the seat 10.

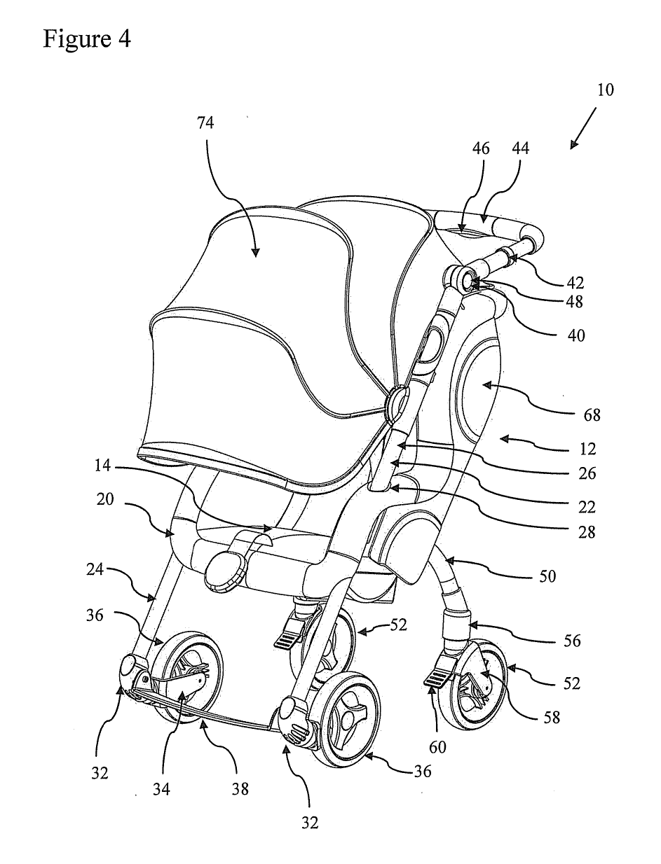

Referring now to FIG. 4, a weatherproof cover 74 is provided to protect the occupant from sun and/or rain. The cover 74 is mounted to the outer telescopic element 26. The cover may be foldable and may be removable.

The seat 10 is shown in, FIG. 1 in an operative condition in which the seat 10 is suitable for use as a push chair. The telescopic front legs 22 are extended and the pivotally mounted rear legs 50 are pivoted so that both sets of wheels 36,52 are spaced from the base of the seat 12. The front legs extend by around 350 mm, and hence the base of the seat is elevated from the ground by around 350 mm. This is a fairly standard ride height for a child's pushchair and gives the child ample leg room. The seat 10 is shown in FIG. 2 in a stowed condition in which the seat 10 is suitable for use as a child car seat and in which the telescopic legs 22 are contracted and the pivotally mounted legs 50 are pivoted so that both sets of wheels 36, 52 are disposed adjacent to the seat 12.

The car seat 10 can be placed on the rear seat of a vehicle in the contracted or stowed mode and fastened in known manner using the standard ISOFIX connection 70. A child can be transported in the seat and fastened in using the harness 72. On arriving at a destination, the child can be unclipped and removed from the seat temporarily. The ISOFIX fastening can then be released and the seat removed from the vehicle. The lever 62 is then pulled downwardly away from the back of the seat, which operates the Bowden cables 64. This releases the lower inner elements 24 of the telescopic legs, which can be extended, and also releases the rear legs 50, which can then be freely rotated to a downward position. The telescopic legs and rotary legs lock into their downward or operative positions automatically, and the seat 10 is then in pushchair mode. The position of the handle 44 can then be set, as desired, by using the telescopic and rotary adjustments on operation of the push buttons 46 and 48. The brake 60 can then be applied, before a child is placed in the seat and fastened in using the harness 72. In one embodiment, movement of the front and rear legs 22, 50 can be assisted, for example, by internal springs or gas rams.

To return the seat 10 to the folded or stowed condition after use, the lever 62 is operated, which again releases the locking mechanisms allowing the inner elements 24 to be moved upwardly, for example, under the weight of the seat. The rear legs also rotate at least partially under the weight of the seat. When finally stowed, they lock into position automatically. The handle can also be moved back to the stowed position above the seat by operation of the push buttons 46 and 48.

The seat 10 is transformable between a car seat and a pushchair. Advantageously, in pushchair mode, the base of the seat is raised off the ground by around 350 mm. The pushchair can be steered, braked and covered and provides substantially all of the advantages of conventional pushchairs, whilst being capable of being folded for use as a car seat. This is particularly useful when travelling with a car or other vehicle, because only one piece of child carriage apparatus need be utilised and carried.

1. A car seat for a child comprising:
a seat, the seat having a seat squab, a seat back, and first and second seat sides;
first and second telescopic legs mounting respective first and second wheels, the first and second wheels being moveable between a stowed position adjacent to the first and second seat sides and an operative position spaced from the seat;
first and second pivotally mounted legs mounting respective third and fourth wheels, the third and fourth wheels being moveable from a stowed position adjacent to the seat and an operative position spaced from the seat.

2. A seat as claimed in claim 1, in which a first locking mechanism is provided for locking the first and second pivotally mounted legs in the stowed or operative position, and a second locking mechanism is provided for locking the first and second telescopic legs in the stowed or operative position, and in which at least one control means is provided to disengage at least one of the locking mechanisms.

3. A seat as claimed in claim 2, in which at least one of the locking mechanisms consists of at least one sprung pin.

4. A seat as claimed in claim 2, in which at least one of the locking mechanisms consists of a toothed wheel and pin.

5. A seat as claimed in claim 2, in which at least one of the locking mechanisms can be engaged with the wheels in substantially any position.

6. A seat as claimed in claim 2, in which at least one of the locking mechanisms is engaged automatically when at least one of the legs is in either the stowed position or the operative position.

7. A seat as claimed in claim 2, in which a single control means is provided for disengaging both of the first and second locking mechanisms.

8. A seat as claimed in claim 2, in which at least one locking mechanism can be operated independently of at least 5 one other locking mechanism.

9. A seat as claimed in claim 8, in which control means are provided consisting of a first lever which disengages the first locking mechanism, and a second lever which disengages the second locking mechanism.

10. A seat as claimed in claim 8, in which the first and second levers are operably connected, the second lever causing movement of the first lever.

11. A seat as claimed in claim 8, in which a single lever is provided, which when actuated initially disengages only the first locking mechanism, and when further actuated disengages also the second locking mechanism.

12. A seat as claimed in claim 2, in which a cable is provided to connect at least one of the locking mechanisms with its control means.

13. A seat as claimed in claim 1, in which a spring is provided to bias at least one of the moveable legs to the operative and/or the stowed position.

14. A seat as claimed in claim 1, in which resistance means are provided to apply controlled resistance to the movement of at least one of the moveable legs.

15. A seat as claimed in claim 1, in which a spar is disposed between the first and second telescopic legs to form a footrest.

16. (cancel)

17. (cancel)

18. A seat as claimed in claim 1, in which an adjustable handle is provided to facilitate handling of the seat.

19. A seat as claimed in claim 18, in which the angle of the handle with respect to the first and second telescopic legs is adjustable.

20. A seat as claimed in claim 18, in which the handle is mounted on telescopic members.

21. (cancel)

22. A seat as claimed claim 1, in which a rim is provided at the edges of the seat sides.

23. A seat as claimed in claim 22, in which covers are provided extending from the rim and substantially parallel to the first and second seat sides, the covers defining spaces between the covers and seat sides for accommodating the wheels within the stowed position.

24. (cancel)
